(19) United States
(12) Patent Application Publication
(10) Pub. No.: US 2013/0215053 A1
(43) Pub. Date: Aug. 22, 2013

(54) ANTI-INTERFERENCE DRIVING METHOD OF TOUCH PANEL AND TOUCH PANEL DEVICE USING THE SAME

(71) Applicant: ELAN MICROELECTRONICS CORPORATION, (US)

(72) Inventors: Chia-Hsing LIN, Hsinchu City (TW); Yi-Hsin TAO, Hsinchu City (TW)

(73) Assignee: ELAN MICROELECTRONICS CORPORATION, Hsin Chu (TW)

(21) Appl. No.: 13/761,499

(22) Filed: Feb. 7, 2013

(30) Foreign Application Priority Data
Feb. 17, 2012 (TW) 101105215

(51) Int. Cl. G06F 3/041

(52) U.S. Cl. CPC G06F 3/041
USPC 345/173

(57) ABSTRACT

An anti-interference driving method of touch panel has steps of providing a touch panel and outputting multiple excitation signal sets to the respective driving lines of the touch panel. The touch panel has multiple driving lines and multiple receiving lines. Each driving line has multiple sub-driving lines. Each excitation signal set has multiple excitation signals sequentially outputted to the corresponding sub-driving lines. The excitation signals outputted to any adjacent two sub-driving lines are reversed in phase and a time gap between the excitation signals with reverse phases is less than a cycle of each excitation signal. Accordingly, two sensing signals having coupled capacitance values of a noise with different signs is obtained by using a receiving line to sense any adjacent two sub-driving lines and can be directly processed to remove the coupled capacitance value of the noise.

### BACKGROUND OF THE INVENTION

1. Field of the Invention

The present invention relates to a touch panel and more particularly to an anti-interference driving method of touch panel and a touch panel using the same.

2. Description of the Related Art

With reference to FIG. 6A, a conventional touch panel has multiple driving lines TX1˜TX4 and multiple receiving lines RX1˜RX4. Each driving line TX1˜TX4 is intersected with each receiving line RX1˜RX4 to constitute a sensing point. The driving lines TX1˜TX4 respectively receive excitation signals, and when the excitation signals are inputted, each sensing point becomes a coupling capacitor. Each receiving line RX1˜RX4 is connected to a receiving circuit 31. When the driving line TX₂ receives an excitation signal, the receiving circuits 31 of the receiving lines RX1˜RX4 start receiving sensing signals. With reference to FIG. 6B, each receiving circuit 31 at least has a sample holding circuit 311 and an analog-to-digital converter (ADC) 312. The sample holding circuit 311 is connected to a corresponding receiving line RX1˜RX4. The ADC 312 acquires sensed capacitance values (ADC values) of each sensing point through the sample holding circuit 311.

With reference FIG. 6C, from the perspective of a sensing point formed by the driving line TX2 and the receiving line RX2, when an excitation signal is inputted to the driving line TX2, the sensing point has a voltage variation or a current variation upon each of a rising edge t1 and a falling edge t2 of each high state period Tlh of the excitation signal. Hence, the sample holding circuit 311 can perform signal sampling upon the rising edge t1 or the falling edge t2 for the ADC 312 to convert the sampled signal into a sensed capacitance value −C22 during a low state period Thl of the excitation signal. Furthermore, as to the design of the receiving circuit 31, if the sample holding circuit 311 only performs signal sampling upon the rising edge t1 or the falling edge t2 of each high state period Tlh of the excitation signal, the ADC 312 can be designed with a non-pipeline ADC. If higher signal to noise ratio (SNR) is of concern, a pipeline ADC can be also adopted, and the sample holding circuit 311 can perform signal sampling upon both the rising edge t1 and the falling edge t2 to intensify the sampled signals and increase the SNR. With reference to FIG. 6D, another receiving circuit 31′ is shown and has two sets of parallelly connected sampling holding circuits 31′ and non-pipeline ADCs 312, and a multiplexer 313. The multiplexer 313 serves to switch the two non-pipeline ADCs 312 to convert the sampled signals upon the rising edges t1 and the falling edges t2 of the high state periods Tlh of the excitation signals.

With further reference to FIG. 6A, when a touch panel 60 has no touch object thereon, the sensed capacitance value −C₂₂ of each sensing point can be acquired when the excitation signals are applied. When a touch object appears on a sensing point determined by a driving line TX2 and a receiving line RX2 of a touch panel 60 as shown in FIG. 7A, the touch point absorbs partial energy of the excitation signal stored in the sensing point as being a good conductor. Hence, the sensed capacitance value converted by the ADC is −C₂₂+Δ C₂₂. This is a regular method using the variations of the capacitance values at the sensing points to determine if a touch object is available.

However, when the touch object has a bad grounding, environmental noises originally bypassed through a grounding path of touch object are sensed by the touch panel through a capacitive coupling effect of the touch object to result in variations of the sensed capacitance values and incorrect determination of the position of the touch object. With reference to FIG. 7B, when the noises of a finger (touch object 50) is capacitively coupled to a receiving line RX2 and a driving line TX2 happens to receive an excitation signal, the sensed capacitance value of the sensing point thus becomes −C₂₂+Δ Cₙ₂₂ due to the noises. If Cₙ₂₂ is large enough to approach to Δ C₂₂, this sensing point may be mistaken as the position of the touch object and therefore a ghost point is caused.

The technical issue of ghost point of the foregoing touch panels 60 arising from the noises can be tackled by the following two anti-interference approaches.

With reference to FIG. 8, a first anti-interference approach further provides a sub-receiving line RX₁′˜RX₄′ formed beside each receiving line RX₁˜RX₄ on a touch panel and connected to a receiving circuit 31. As each sub-receiving line is very close to a corresponding receiving line RX1˜RX4, the noise of a touch object 50 can be simultaneously coupled to a corresponding receiving line RX₁˜RX₄ and its sub-receiving line RX₁′˜RX₄′. When a driving line TX₂ receives an excitation signal, the following sensed capacitance values are respectively converted by the ADCs of the receiving circuits of a receiving line RX₂ and its sub-receiving line RX₂′

C_{S}=|−C₂₂+ΔC₂₂; and

C_{S}′=|−C₂₂′+ΔCₙ₂₂′; where C₂₂>>Cₙ₂₂′, and ΔC₂₂≈ΔCₙ₂₂.

A sensed capacitance value approximating to C₂₂ can be obtained from a difference between the two sensed capacitance values C_{S} and C_{S}′. As a result, the issue of ghost point arising from the noise interference can be eliminated.

With reference to FIG. 9, a second anti-interference approach mainly changes a sampling time of the sample holding circuit and lets the sample holding circuit perform signal sampling within each low state period Thl of the excitation signal. As the low-frequency noise (about several hundred KHz) that are close to a sampling frequency

$$( fs \approx \frac{1}{10 RC} )$$

of the sample holding circuit exist during the cycle of an excitation signal, the sampled signal acquired during the low state period Thl is completely the sensed capacitance value ΔCₙ₂₂′ generated by the noises, a sensed capacitance value close to C₂₂ can be obtained by subtracting the sensed capacitance value ΔCₙ₂₂′ from a sensed capacitance value C_{S}=−C₂₂+ΔC₂₂ converted during the high state period Tlh.

Although the first anti-interference approach can rule out the issue of ghost point arising from noises, not only should the layout of the sensing lines of a touch panel be changed, but also each sub-receiving line needs one additional receiving circuit. The circuit components of the receiving circuit are complicated and therefore relatively increase the cost in manufacturing the receiving circuit. Despite no layout change of the sensing lines of a touch panel, due to the limitation of the sampling frequency, the second anti-interference approach can only get rid of the interference caused by low-frequency noises but fails to eliminate high-frequency noises.

### SUMMARY OF THE INVENTION

An objective of the present invention is to provide an anti-interference driving method of touch panel and a touch panel device using the method capable of eliminating high-frequency noise interference and reducing the circuit cost.

To achieve the foregoing objective, the anti-interference driving method has steps of:

providing a touch panel; and

outputting multiple excitation signal sets to the respective driving lines of the touch panel.

The touch panel has multiple driving lines and multiple receiving lines. Each driving line has multiple sub-driving lines.

Each excitation signal set has multiple excitation signals sequentially outputted to the corresponding sub-driving lines. The excitation signals outputted to any adjacent two sub-driving lines are reversed in phase. A time gap between the excitation signals with reverse phases is less than a cycle of each excitation signal.

To achieve the foregoing objective, the touch panel device has a touch panel and a touch control circuit unit.

The touch panel has multiple driving lines and multiple receiving lines. Each driving line has multiple sub-driving lines.

The touch control circuit unit has a driving unit connected to the driving lines of the touch panel and outputting multiple excitation signal sets to the respective driving lines. Each excitation signal set has multiple excitation signals sequentially outputted to the corresponding sub-driving lines. The excitation signals outputted to any adjacent two sub-driving lines are reversed in phase. A time gap between the excitation signals with reversed phase is less than a cycle of an excitation signal.

Each driving line on the touch panel has multiple sub-driving lines being close to each other. When a noise of a touch object is coupled to a driving line, all or most of the sub-driving lines are coupled to sense the noise. The time gap between the excitation signals outputted to any adjacent two of the sub-driving lines is set to be less than a cycle of each excitation signal so that a corresponding receiving line can sense a noise with a frequency higher than the frequency of each excitation signal. Moreover, the excitation signals outputted to adjacent two of the sub-driving lines are adjusted to have reverse phases so that the capacitance values of the noise contained in the sensing signals of the two adjacent sub-driving lines sensed by the receiving circuits of an identical receiving line also have reverse signs. Accordingly, the two sensing signals can be directly added together to eliminate the coupled capacitance value of the noise and rule out the interference arising from the noise.

Other objectives, advantages and novel features of the invention will become more apparent from the following detailed description when taken in conjunction with the accompanying drawings.

### BRIEF DESCRIPTION OF THE DRAWINGS

FIG. 1 is a schematic sensor layout diagram of a touch panel in accordance with the present invention;

FIG. 2A is a timing diagram of two excitation signals of an excitation signal set in accordance with the present invention;

FIG. 2B is a timing diagram of three excitation signals of another excitation signal set in accordance with the present invention;

FIG. 3A is a schematic sensor layout diagram of a touch panel having diamond-type sensors in accordance with the present invention;

FIG. 3B is a schematic sensor layout diagram of a first touch panel having straight bar sensors in accordance with the present invention;

FIG. 3C is a schematic sensor layout diagram of a second touch panel having straight bar sensors in accordance with the present invention;

FIG. 3D is a schematic sensor layout diagram of a third touch panel having straight bar sensors in accordance with the present invention;

FIG. 3E is a schematic sensor layout diagram of a fourth touch panel having straight bar sensors in accordance with the present invention;

FIG. 4 is a schematic diagram of a touch panel device in accordance with the present invention;

FIG. 5 is a waveform diagram containing waveforms associated with driving signals and receiving signals in FIGS. 2A and 3A;

FIG. 6A is a schematic sensor layout diagram of a conventional touch panel;

FIG. 6B is a functional block diagram of a conventional receiving circuit;

FIG. 6C is a waveform diagram containing waveforms associated with driving signals and receiving signals of the conventional touch panel in FIG. 6A;

FIG. 6D is a functional block diagram of another conventional receiving circuit;

FIG. 7A is a schematic sensor layout diagram of the touch panel in FIG. 6A with a well-grounded touch object thereon;

FIG. 7B is a schematic sensor layout diagram of the touch panel in FIG. 6A with a poorly grounded touch object thereon;

FIG. 8 is a schematic sensor layout diagram of a conventional anti-interference touch panel; and

FIG. 9 is a schematic sensor layout diagram of another conventional anti-interference touch panel.

### DETAILED DESCRIPTION OF THE INVENTION

An anti-interference driving method of touch panel in accordance with the present invention has the following steps:

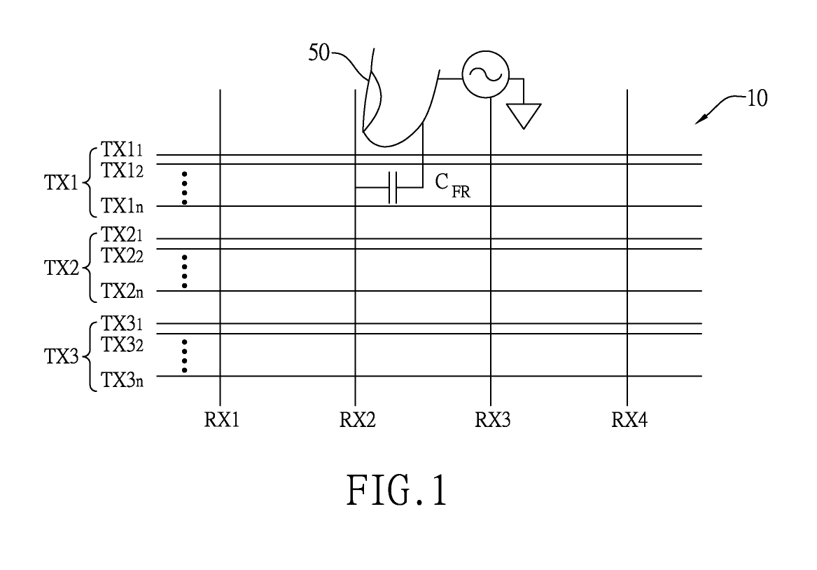

Step 1: Provide a touch panel 10 as shown in FIG. 1. The touch panel 10 has multiple driving lines TX1˜TX3 and multiple receiving lines RX1˜RX4. Each driving line TX1˜TX3 has multiple sub-driving lines TX1₁˜TX1ₙ, TX2₁˜TX2ₙ and TX3₁˜TX3ₙ.

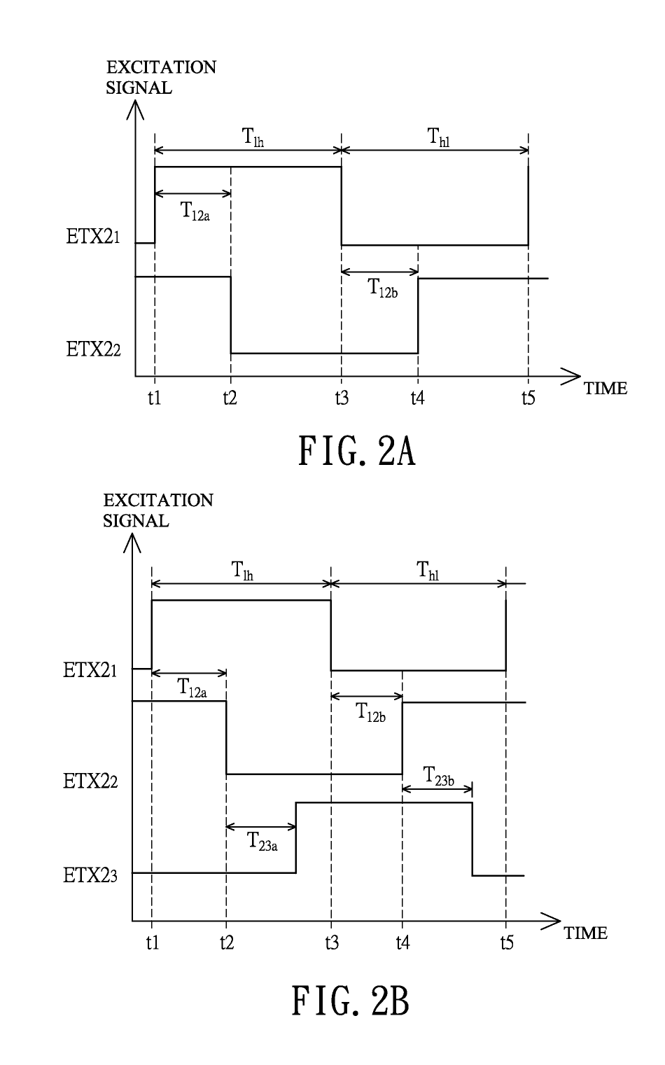

Step 2: Output multiple excitation signal sets to the respective driving lines TX1˜TX3 of the touch panel 10. With reference to FIGS. 2A and 2B, each excitation signal set has multiple excitation signals ETX2₁˜ETX2₂, ETX2₁˜ETX2₃ sequentially outputted to the corresponding sub-driving lines TX2₁˜TX2₂, TX2₁˜TX2₃. The excitation signals ETX2₁˜ETX2₂ outputted to any adjacent two sub-driving lines TX2₁˜TX2₂ are reversed in phase and a time gap between the excitation signals ETX2₁˜ETX2₂ is less than a cycle of an excitation signal. In the present embodiment, the cycle of the excitation signal is a high state period Tlh and is greater than a delay time T₁₂ₐ, which is a sample holding time required by a sample holding circuit. In FIG. 2A, a timing diagram of two excitation signals ETX2₁, ETX2₂ of the two sub-driving lines TX2₁, TX2₂ is shown. The excitation signals ETX2₁, ETX2₂ are sequentially transmitted to the two sub-driving lines TX2₁, TX2₂. In FIG. 2B, a timing diagram of three excitation signals ETX2₁, ETX2₂, ETX2₃ of the three sub-driving lines TX2₁, TX2₂, TX2₃ is shown. The excitation signals ETX2₁, ETX2₂, ETX2₃ are sequentially transmitted to the three sub-driving lines TX2₁, TX2₂, TX2₃.

The physical sensor layouts of the driving lines and the receiving lines of the foregoing touch panel can be further described by the common touch panels having diamond-type sensors and straight bar sensors.

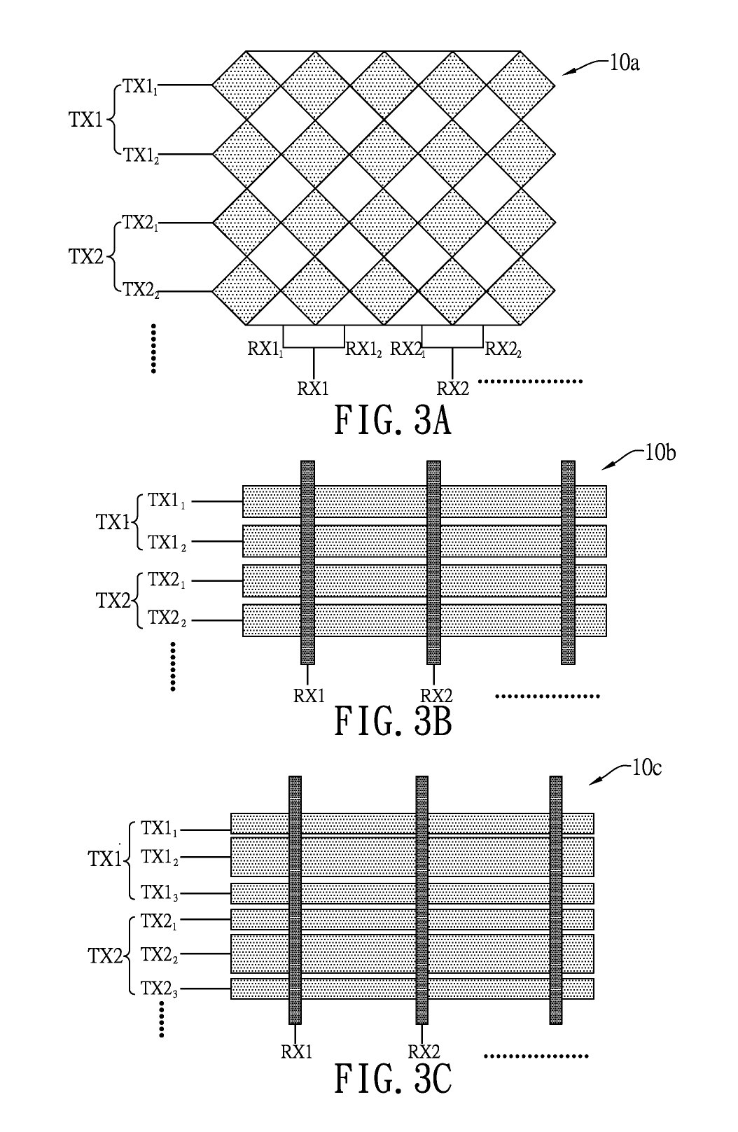

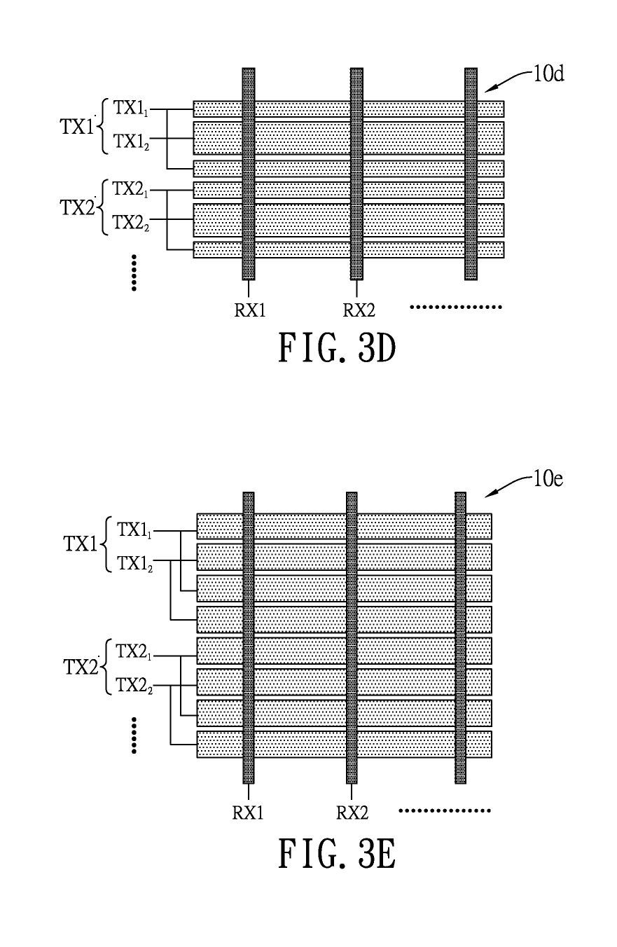

With reference to FIG. 3A, a touch panel 10a having diamond-type sensors in accordance with the present invention divides each driving line TX1, TX2 of a regular touch panel having diamond-type sensors into two sub-driving lines (TX1₁, TX1₂), (TX2₁, TX2₂). Each sub-driving line is constituted by multiple diamond-shaped sensing pads. Similarly, each receiving line RX1, RX2 is divided into two sub-receiving lines (RX1₁, RX1₂), (RX2₁, RX2₂), and each sub-receiving line is constituted by multiple diamond-shaped sensing pads. Same ends of each two divided sub-receiving lines (RX1₁, RX1₂), (RX2₁, RX2₂) are commonly connected to an original corresponding receiving unit. Hence, it is unnecessary for the receiving circuit to add any receiving unit because of the divided receiving lines.

With reference to FIGS. 3B to 3D, three types of touch panel having straight bar sensors in accordance with the present invention are shown. Each driving line of a first touch panel 10b having straight bar sensors is divided into two sub-driving lines TX1₁, TX1₂ having identical areas. The receiving lines RX1, RX2 are not divided and remain as single receiving lines. Each driving line of a second touch panel 10c having straight bar sensors is divided into three sub-driving lines TX1₁, TX1₂, TX1₂, which may have different areas. A third touch panel 10d having straight bar sensors is substantially the same as the second touch panel 10c having straight bar sensors except that common ends of the first and third sub-driving lines TX2₁, TX2₃ are connected so that the three sub-driving lines can be driven by the excitation signals ETX2₁, ETX2₂ in FIG. 2A. With reference to FIG. 3E, a fourth touch panel 10e having straight bar sensors has an even number (greater than 2) of sub-driving lines. In the present embodiment, there are four sub-driving lines. Common ends of the first and third sub-driving lines TX2₁, TX2₃ are connected, and common ends of the second and fourth sub-driving lines TX2₂, TX2₄ are connected so that the four sub-driving lines can be driven by the excitation signals ETX2₁, ETX2₂ in FIG. 2A. In other words, the number of the sub-driving lines n1 is k times of the number of the excitation signals n2 contained in the excitation signal set where n1>n2 and each excitation signal can be simultaneously connected to k sub-driving lines.

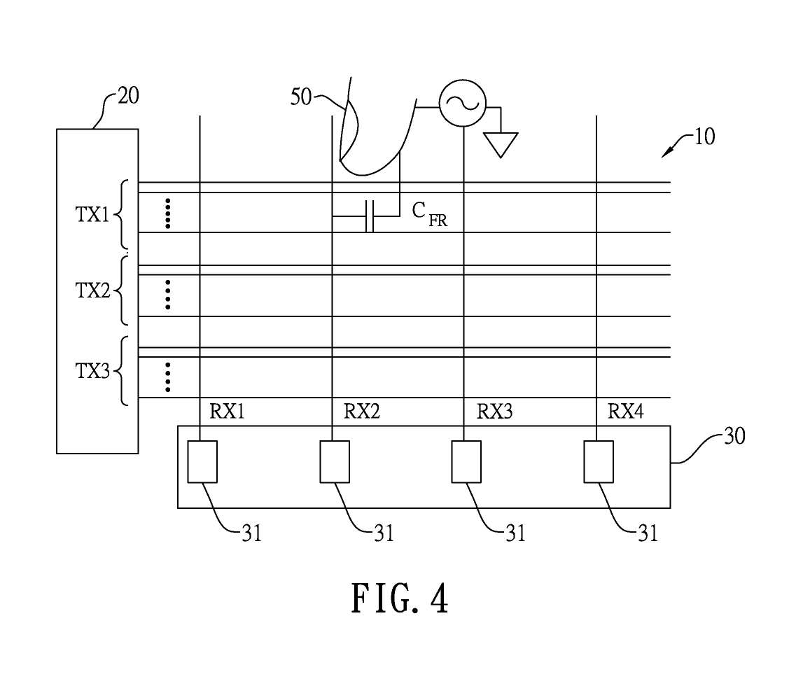

With reference to FIG. 4, a touch panel device in accordance with the present invention has a touch panel 10 and a touch control circuit unit.

The touch panel 10 has multiple driving lines TX1˜TX3 and multiple receiving lines RX1˜RX4. Each driving line TX1˜TX3 is constituted by multiple sub-driving lines. The touch panel 10 can be implemented as the touch panels in FIGS. 3A to 3E and is not further described here.

The touch control circuit unit has a driving unit 20 and a receiving unit 30. The driving unit 20 is connected to the driving lines TX1˜TX3 of the touch panel 10. The receiving unit 30 has multiple receiving circuits 31 respectively connected to the receiving lines RX1˜RX4 of the touch panel 10. The driving unit 20 outputs multiple excitation signal sets to the respective driving lines TX1˜TX3. With further reference to FIGS. 2A and 2B, each excitation signal set has multiple excitation signals ETX2₁, ETX2₂/ETX2₁˜ETX2₃ sequentially outputted to the corresponding sub-driving lines. The excitation signals outputted to any adjacent two sub-driving lines are reversed in phase and a time gap between the excitation signals is less than a cycle of an excitation signal. In the present embodiment, the cycle of the excitation signal is the high state period Tlh or the low state period Thl. As the receiving circuit 31 at least has a sample holding circuit and an ADC, the time gap between two consecutive excitation signals should not be less than the sample holding time T₁₂ₐ.

The operation of the present invention using the foregoing method and device to suppress the interference caused by the noises carried by a touch object is described as follows.

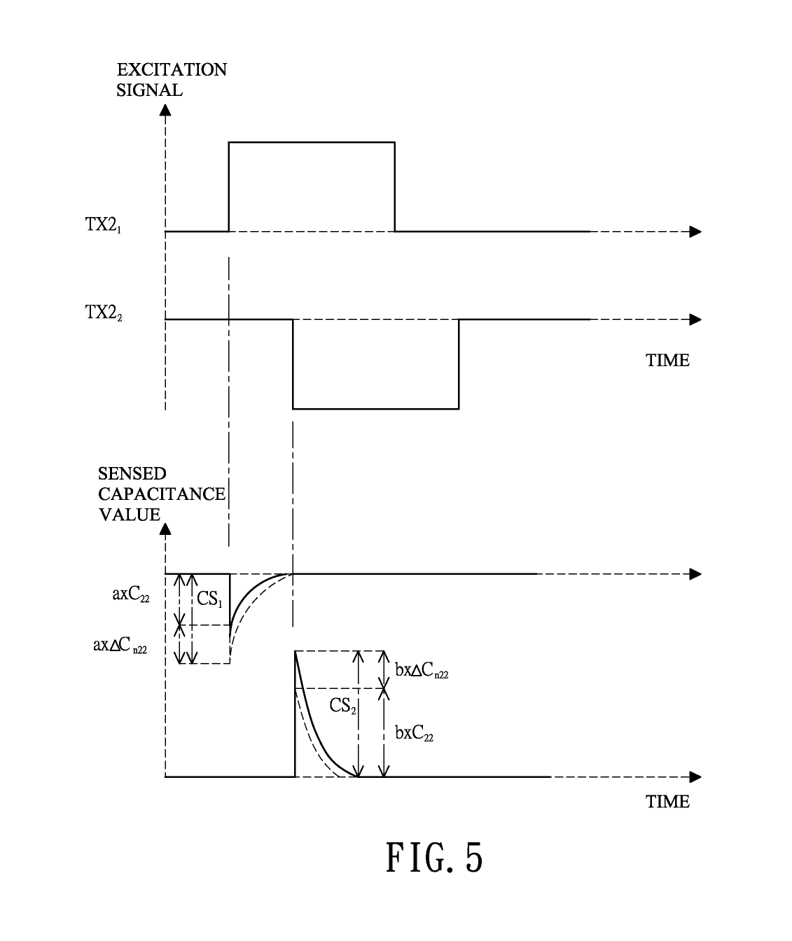

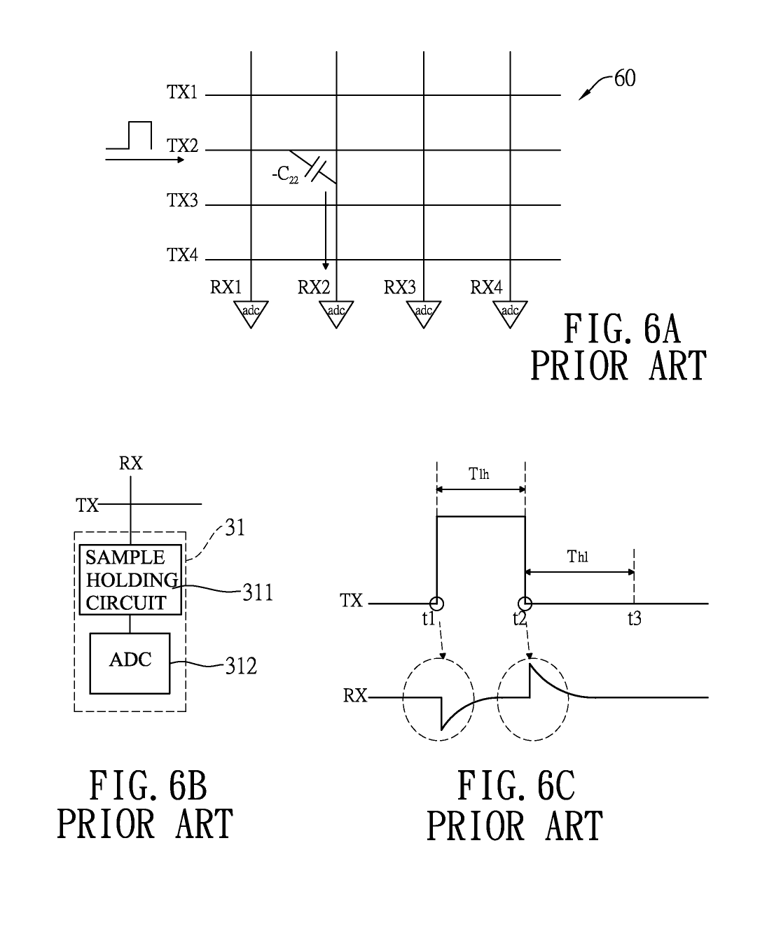

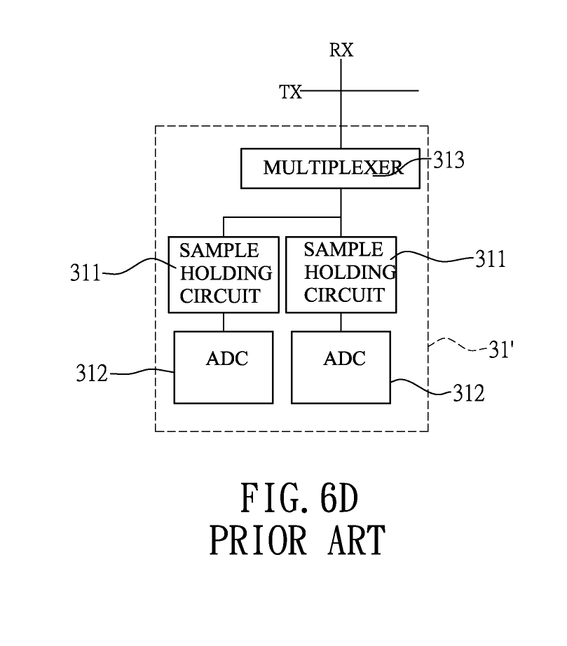

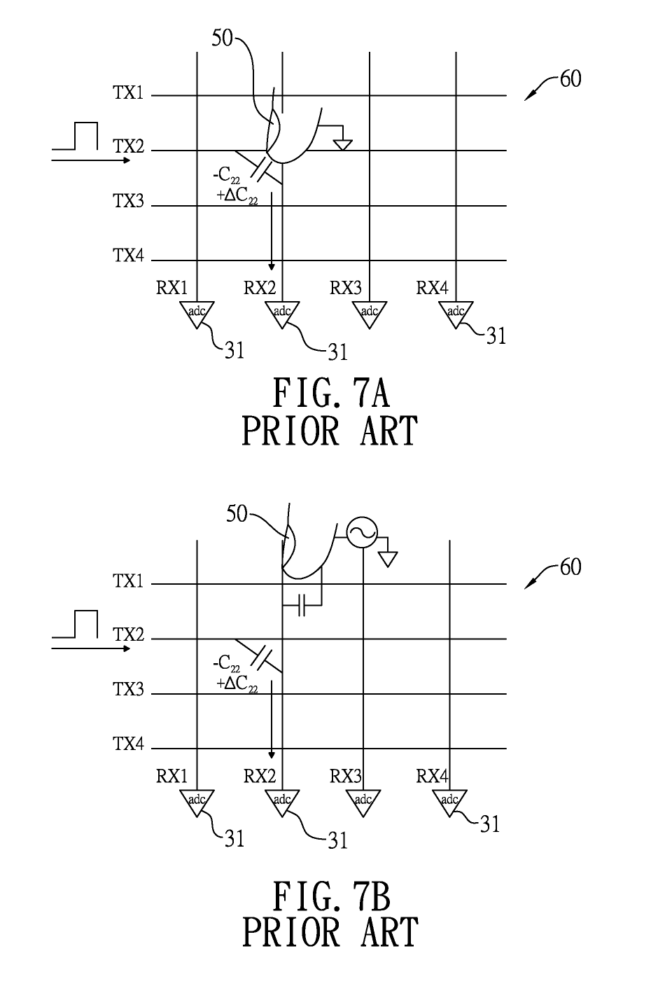

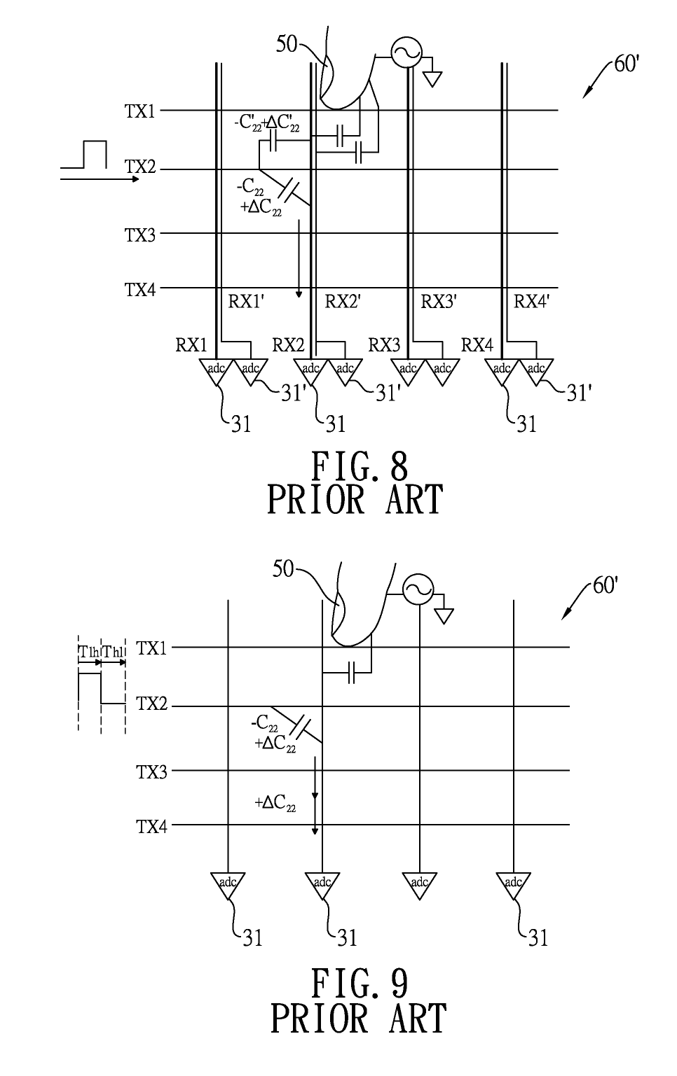

With reference to FIGS. 2A, 4 and 5, as the sub-driving lines (for example two sub-driving lines) are close to each other, when a touch object 50 approaches a sensing point intersected by the second driving line TX2 and the second receiving line RX2, noises of the touch object 50 are sensed by the receiving line RX2 through a coupling capacitor C_{FR} between the touch object 50 and the second receiving line RX2. Also from the excitation signals ETX2₁, ETX2₂ outputted to the sub-driving lines TX2₁, TX2₂ of the second driving line TX2, as the time gap between the two excitation signals ETX2₁, ETX2₂ is less than a high state period Tlh, the receiving circuit 31 of the second receiving line RX2 receives two sensed capacitance values during the high state period. If the sensed capacitance value of the coupled noises is a positive value, the second receiving line RX2 then senses a negative capacitance value C_{S1} at the rising edge t1 of the first excitation signal ETX2₁. As the second excitation signal ETX2₂ and the first excitation signal ETX2₁ are reversed in phase, in response to the positive sensed capacitive value of the noises, a positive capacitance value C_{S2} is similarly sensed at the falling edge t2 of the second excitation signal. During a practical operation, absolute values of the negative capacitance value C_{S1} and the positive capacitance value C_{S2} are taken and expressed by the following two equations.

C_{S1}=|a×(−C₂₂)+a×ΔCₙ₂₂| (1)

C_{S2}=|b×C₂₂+b×ΔCₙ₂₂| (2)

where a, b are the area ratios of the two sub-driving lines.

Since C_{S1}, C_{S2}, a and b are known, assuming that a=b=1/2, the receiving circuit of the second receiving line adds equations 1 and 2 together to obtain a sensed capacitance value C₂₂ approximating to a sensed capacitance value sensed when a corresponding driving line is free of noise interference, and the interference caused by the noises can be eliminated.

According to FIGS. 2B and 3C, the driving lines are driven and the receiving circuit 31 of the second receiving line RX2 obtains three sensed capacitance values expressed by the following equations:

C_{S1}=|a×(−C₂₂)+a×ΔCₙ₂₂| (1)

C_{S2}=|b×C₂₂+b×ΔCₙ₂₂| (2)

C_{S3}=|c×(−C₂₂)+c×ΔCₙ₂₂| (3)

where a, b, c are the area ratios of the three sub-driving lines.

Suppose that a=c=1/4 and b=1/2. After C_{S1}, C_{S2} and C_{S2} are added together, a sensed capacitance value C₂₂ approximating to a sensed capacitance value sensed when a corresponding driving line is free of noise interference.

From the foregoing, each driving line on the touch panel of the present invention has multiple sub-driving lines adjacent to each other. When a noise of a touch object is coupled to one of the driving lines, all or most of the sub-driving lines of the driving line are coupled to sense the noise. A time gap between two consecutive excitation signals outputted to the sub-driving lines is maintained to be less than one high state period so that the corresponding receiving line can sense the noise with a frequency higher than those of the excitation signals. Moreover, by adjusting the excitation signals of any adjacent two of the driving lines to be reversed in phase, two sensing signals having the sensed capacitance values of the noise coupled therein from adjacent two of the driving lines can be obtained by the receiving circuit of a corresponding receiving line at two different timings and the capacitance values of the noises in the two sensing signals have different signs. Accordingly, the capacitance values of the noise can be counter-balanced by direct processing of the sensing signals and the interference caused by the noise can be easily removed. Despite minor addition of the sub-driving lines, the overall cost of the present invention is still lower than those of the conventional anti-interference approaches as the cost of a driving circuit is still relatively lower than that of a receiving circuit. Additionally, because the time gap between the excitation signals to the sub-driving lines is smaller than the high state period of an excitation signal, the capacitance value of noise with a frequency higher than the sampling frequency can be easily sensed and removed.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An anti-interference driving method of touch panel comprising steps of:
providing a touch panel, wherein the touch panel has:
multiple driving lines, each driving line having multiple sub-driving lines; and
multiple receiving lines;
outputting multiple excitation signal sets to the respective driving lines of the touch panel, wherein each excitation signal set has multiple excitation signals sequentially outputted to the corresponding sub-driving lines, and the excitation signals outputted to any adjacent two sub-driving lines are reversed in phase and a time gap between the excitation signals with reverse phases is less than a cycle of each excitation signal.

2. The anti-interference driving method as claimed in claim 1, wherein each driving line has an even number of sub-driving lines.

3. The anti-interference driving method as claimed in claim 1, wherein each driving line has an odd number of sub-driving lines being greater than one.

4. The anti-interference driving method as claimed in claim 2, wherein each excitation signal set has a count of excitation signals identical to the number of the sub-driving lines of each driving line, and the excitation signals of each excitation signal set is respectively outputted to the sub-driving lines of each driving line.

5. The anti-interference driving method as claimed in claim 3, wherein each excitation signal set has a count of excitation signals identical to the number of the sub-driving lines of each driving line, and the excitation signals of each excitation signal set is respectively outputted to the sub-driving lines of each driving line.

6. The anti-interference driving method as claimed in claim 2, wherein a count of the sub-driving lines of each driving line is equal to k times of a count of the excitation signals in each excitation signal set, the count of the sub-driving lines in each driving line is greater than that of the excitation signals in each excitation signal set, and each excitation signal is connected to k sub-driving lines in each driving line.

7. The anti-interference driving method as claimed in claim 1, wherein each driving line has more than three sub-driving lines, and each excitation signal set has a count of the excitation signals thereof less than that of the sub-driving lines of each driving line.

8. The anti-interference driving method as claimed in claim 1, wherein a time gap between two of the excitation signals in each excitation signal set outputted to any adjacent two of the sub-driving lines of each driving line is less than a cycle of each excitation signal and is greater than a delay time.

9. The anti-interference driving method as claimed in claim 2, wherein a time gap between two of the excitation signals in each excitation signal set outputted to any adjacent two of the sub-driving lines of each driving line is less than a cycle of each excitation signal and is greater than a delay time.

10. The anti-interference driving method as claimed in claim 3, wherein a time gap between two of the excitation signals in each excitation signal set outputted to any adjacent two of the sub-driving lines of each driving line is less than a cycle of each excitation signal and is greater than a delay time.

11. The anti-interference driving method as claimed in claim 4, wherein a time gap between two of the excitation signals in each excitation signal set outputted to any adjacent two of the sub-driving lines of each driving line is less than a cycle of each excitation signal and is greater than a delay time.

12. The anti-interference driving method as claimed in claim 5, wherein a time gap between two of the excitation signals in each excitation signal set outputted to any adjacent two of the sub-driving lines of each driving line is less than a cycle of each excitation signal and is greater than a delay time.

13. The anti-interference driving method as claimed in claim 6, wherein a time gap between two of the excitation signals in each excitation signal set outputted to any adjacent two of the sub-driving lines of each driving line is less than a cycle of each excitation signal and is greater than a delay time.

14. The anti-interference driving method as claimed in claim 7, wherein a time gap between two of the excitation signals in each excitation signal set outputted to any adjacent two of the sub-driving lines of each driving line is less than a cycle of each excitation signal and is greater than a delay time.

15. The anti-interference driving method as claimed in claim 8, wherein the delay time is a sample holding time.

16. The anti-interference driving method as claimed in claim 9, wherein the delay time is a sample holding time.

17. The anti-interference driving method as claimed in claim 10, wherein the delay time is a sample holding time.

18. The anti-interference driving method as claimed in claim 11, wherein the delay time is a sample holding time.

19. The anti-interference driving method as claimed in claim 12, wherein the delay time is a sample holding time.

20. The anti-interference driving method as claimed in claim 13, wherein the delay time is a sample holding time.

21. The anti-interference driving method as claimed in claim 14, wherein the delay time is a sample holding time.

22. A touch panel device comprising:
a touch panel having:
multiple driving lines, each driving line having multiple sub-driving lines; and
multiple receiving lines; and
a touch control circuit unit having a driving unit connected to the driving lines of the touch panel and outputting multiple excitation signal sets to the respective driving lines, wherein each excitation signal set has multiple excitation signals sequentially outputted to the corresponding sub-driving lines, the excitation signals outputted to any adjacent two sub-driving lines are reversed in phase, and a time gap between the excitation signals with reversed phase is less than a cycle of an excitation signal.

23. The touch panel device as claimed in claim 22, wherein each driving line has an even number of sub-driving lines.

24. The touch panel device as claimed in claim 22, wherein each driving line has an odd number of sub-driving lines being greater than one.

25. The touch panel device as claimed in claim 23, wherein each excitation signal set has a count of excitation signals identical to the number of the sub-driving lines of each driving line, and the excitation signals of each excitation signal set is respectively outputted to the sub-driving lines of each driving line.

26. The touch panel device as claimed in claim 24, wherein each excitation signal set has a count of excitation signals identical to the number of the sub-driving lines of each driving line, and the excitation signals of each excitation signal set is respectively outputted to the sub-driving lines of each driving line.

27. The touch panel device as claimed in claim 23, wherein a count of the sub-driving lines of each driving line is k times of a count of the excitation signals in each excitation signal set, k is a positive nonzero integer, and each excitation signal is simultaneously connected to k sub-driving lines in each driving line.

28. The touch panel device as claimed in claim 22, wherein each driving line has more than three sub-driving lines, and each excitation signal set has a count of the excitation signals thereof less than that of the sub-driving lines of each driving line.

29. The touch panel device as claimed in claim 22, wherein a time gap between two of the excitation signals in each excitation signal set outputted to any adjacent two of the sub-driving lines of each driving line is less than a cycle of each excitation signal and is greater than a delay time.

30. The touch panel device as claimed in claim 23, wherein a time gap between two of the excitation signals in each excitation signal set outputted to any adjacent two of the sub-driving lines of each driving line is less than a cycle of each excitation signal and is greater than a delay time.

31. The touch panel device as claimed in claim 24, wherein a time gap between two of the excitation signals in each excitation signal set outputted to any adjacent two of the sub-driving lines of each driving line is less than a cycle of each excitation signal and is greater than a delay time.

32. The touch panel device as claimed in claim 25, wherein a time gap between two of the excitation signals in each excitation signal set outputted to any adjacent two of the sub-driving lines of each driving line is less than a cycle of each excitation signal and is greater than a delay time.

33. The touch panel device as claimed in claim 26, wherein a time gap between two of the excitation signals in each excitation signal set outputted to any adjacent two of the sub-driving lines of each driving line is less than a cycle of each excitation signal and is greater than a delay time.

34. The touch panel device as claimed in claim 27, wherein a time gap between two of the excitation signals in each excitation signal set outputted to any adjacent two of the sub-driving lines of each driving line is less than a cycle of each excitation signal and is greater than a delay time.

35. The touch panel device as claimed in claim 28, wherein a time gap between two of the excitation signals in each excitation signal set outputted to any adjacent two of the sub-driving lines of each driving line is less than a cycle of each excitation signal and is greater than a delay time.

36. The touch panel device as claimed in claim 29, wherein the touch control circuit unit further has a receiving unit, the receiving unit has multiple receiving circuits respectively connected to the receiving lines, each receiving circuit has a sample holding circuit, and the delay time is a sample holding time of the sample holding circuit.

37. The touch panel device as claimed in claim 30, wherein the touch control circuit unit further has a receiving unit, the receiving unit has multiple receiving circuits respectively connected to the receiving lines, each receiving circuit has a sample holding circuit, and the delay time is a sample holding time of the sample holding circuit.

38. The touch panel device as claimed in claim 31, wherein the touch control circuit unit further has a receiving unit, the receiving unit has multiple receiving circuits respectively connected to the receiving lines, each receiving circuit has a sample holding circuit, and the delay time is a sample holding time of the sample holding circuit.

39. The touch panel device as claimed in claim 32, wherein the touch control circuit unit further has a receiving unit, the receiving unit has multiple receiving circuits respectively connected to the receiving lines, each receiving circuit has a sample holding circuit, and the delay time is a sample holding time of the sample holding circuit.

40. The touch panel device as claimed in claim 33, wherein the touch control circuit unit further has a receiving unit, the receiving unit has multiple receiving circuits respectively connected to the receiving lines, each receiving circuit has a sample holding circuit, and the delay time is a sample holding time of the sample holding circuit.

41. The touch panel device as claimed in claim 34, wherein the touch control circuit unit further has a receiving unit, the receiving unit has multiple receiving circuits respectively connected to the receiving lines, each receiving circuit has a sample holding circuit, and the delay time is a sample holding time of the sample holding circuit.

42. The touch panel device as claimed in claim 35, wherein the touch control circuit unit further has a receiving unit, the receiving unit has multiple receiving circuits respectively connected to the receiving lines, each receiving circuit has a sample holding circuit, and the delay time is a sample holding time of the sample holding circuit.

43. The touch panel device as claimed in claim 36, wherein each receiving circuit receives two sensing signals having coupled capacitance values of a noise from adjacent two of the sub-driving lines in each driving line circuit at two different timings, and the capacitance values of the noises in the two sensing signals are counter-balanced by processing the sensing signals.

44. The touch panel device as claimed in claim 37, wherein each receiving circuit receives two sensing signals having coupled capacitance values of a noise from adjacent two of the sub-driving lines in each driving line circuit at two different timings, and the capacitance values of the noises in the two sensing signals are counter-balanced by processing the sensing signals.

45. The touch panel device as claimed in claim 38, wherein each receiving circuit receives two sensing signals having coupled capacitance values of a noise from adjacent two of the sub-driving lines in each driving line circuit at two different timings, and the capacitance values of the noises in the two sensing signals are counter-balanced by processing the sensing signals.

46. The touch panel device as claimed in claim 39, wherein each receiving circuit receives two sensing signals having coupled capacitance values of a noise from adjacent two of the sub-driving lines in each driving line circuit at two different timings, and the capacitance values of the noises in the two sensing signals are counter-balanced by processing the sensing signals.

47. The touch panel device as claimed in claim 40, wherein each receiving circuit receives two sensing signals having coupled capacitance values of a noise from adjacent two of the sub-driving lines in each driving line circuit at two different timings, and the capacitance values of the noises in the two sensing signals are counter-balanced by processing the sensing signals.

48. The touch panel device as claimed in claim 41, wherein each receiving circuit receives two sensing signals having coupled capacitance values of a noise from adjacent two of the sub-driving lines in each driving line circuit at two different timings, and the capacitance values of the noises in the two sensing signals are counter-balanced by processing the sensing signals.

49. The touch panel device as claimed in claim 42, wherein each receiving circuit receives two sensing signals having coupled capacitance values of a noise from adjacent two of the sub-driving lines in each driving line circuit at two different timings, and the capacitance values of the noises in the two sensing signals are counter-balanced by processing the sensing signals.

50. The touch panel device as claimed in claim 22, wherein the touch panel has multiple diamond-type sensors.

51. The touch panel device as claimed in claim 22, wherein the touch panel has multiple straight bar sensors.
